(19) United States
(12) Patent Application Publication
(10) Pub. No.: US 2009/0052845 A1
(43) Pub. Date: Feb. 26, 2009

(54) Fixing Structure of Optical Cable

(76) Inventor: Shigehiro Oi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/886,723

(22) PCT Filed: Mar. 23, 2005
(86) PCT No.: PCT/JP2005/005222

§ 371 Date: Sep. 20, 2007

(51) Int. Cl. G02B 6/36

(52) U.S. Cl. 385/87

(57) ABSTRACT

A fixing structure of an optical cable, comprising a tubular crimping ring (2) and a tubular crimping seat (3) disposed on the inside of the crimping ring. A projected part (3b) swelled to the outside at a radius equal to or more than a radius up to the outer periphery of the sheath (12b) of the optical cable (12) to the outer surface of a tension member wire (12c) is formed on the outer peripheral part of the crimping seat between the front end face of the crimping seat and the front end of the sheath (12b). The sheath (12b) and the tension member wire (12c) of the optical cable (12) or either of the sheath and the tension member wire is interposed between the crimping ring and the crimping seat, the optical fibers of the optical cable are inserted into the crimping seat from the rear to the front side, and the crimping ring is caulked to the inside toward the crimping seat to lockingly fix the crimping ring to the crimping seat in the state of forming a step corresponding to the crimping seat in the crimping ring. Thus, the crimping seat cannot be moved backward relative to the crimping ring.

### TECHNICAL FIELD

The present invention relates to a fixing structure of an optical cable, which firmly fixes the optical cable, and is strong against being pulled, in an optical connector and the like used for connecting an optical cable in optical communication.

### BACKGROUND ART

As shown in FIGS. 8 to 9, a conventional optical connector 11, which is disclosed in JP-A-2004-133371 and thus is known, is configured to have a ferule 13 in which an optical fiber 12a of an optical cable 12 is fixed by an adhesive and the like; a holder 14 for holding the ferule 13; a spring 15 disposed at a back side of the holder 14 and continuously biasing the holder 14 toward the front; a plug frame 16 enclosing and holding the above components; a stop ring 17 disposed at a back side of the spring 15 and acting as a receptacle seat; a lug 18 arranged outside the plug frame 16; and a boot 19 disposed to the rear of the stop ring 17 to protect the optical cable 12.

A crimping ring 20 and a crimping seat 21, both of which are made of metal and in a tubular form, are disposed as crimping members inside the stop ring 17. The crimping members separate a sheath (shell) 12b from the optical fiber 12a of the optical cable 12, and hold them with tension wires (for example, Kevlar fibers) 12c.

In detail, as shown in FIG. 9, the sheath 12b of the optical cable 12 is cut at a predetermined end portion using a tool so that the tension wires 12c and the optical fiber 12a are exposed, and then the crimping seat 21 is inserted from that end of the optical fiber 12a. The crimping seat 21 has a stepped portion 21a in its middle in the longitudinal direction, and a sheath holding tube 21b having a small diameter enters between the optical fiber 12a and the tension wires 12c.

Furthermore, the tension wires 12c are cut to the same length near the front end of the crimping seat 21, the crimping ring 20, which had been passed from a front side of the optical cable 12 and arranged at the rear in advance, is returned to the shown location, and then crimped by a crimping tool. Concave portions 20a provided at four places in a circumferential direction at a rear portion of the crimping ring 20, or a concave portion 20a provided in a ring shape near the rear are crimped and thus dig into the sheath 12b, so that the optical cable 12 is prevented from coming off. Moreover, a large-size tubular portion of the crimping seat 21 at the front side of the stepped portion 21a and the crimping ring 20 sandwich the tension wires 12c, so that the crimping seat 21 is crimped, and consequently the optical fiber 12a is fixed.

### DISCLOSURE OF INVENTION

### Problem To Be Solved By The Invention

However, in the method of fixing an optical cable 12 using the crimping members, for example, when the optical cable 12 is drawn to the rear as shown by the arrow in FIG. 9, the crimping seat 21 and the crimping ring 20 are moved to the rear with the optical cable 12, and when a rear end portion of the crimping ring 20 collides with a wall surface of the stop ring 17, the crimping seat 21 may come out through the rear with the optical cable 12 while leaving the crimping ring 20. In this case, the forward end face of the ferule 13 is separated from the end face of the ferule of the cable to which connection has been made, causing interrupted connection in the optical cable communication.

Moreover, in some cases, thickness of the sheath 12b of the optical cable 12 is variously changed, the tension wires 12c are not uniformly dispersed around the optical fiber 12a, or the amount of the tension wires is excessively large or small, so that the crimping condition is changed, and consequently the fixing force by the crimping ring 20 becomes unstable. Furthermore, when concave ring grooves are arranged parallel to one another in the circumferential direction on an inner circumferential wall surface of the crimping ring 20 to increase fixing force by crimping, much effort is required for forming the grooves, resulting in increase in cost.

A fixing structure of an optical cable according to the invention is proposed to solve such problems, preventing the crimping ring from coming out from the crimping seat and securely providing fixing force.

### Means For Solving The Problem

To solve the problems, a fixing structure of an optical cable composed of a optical fiber, a sheath and tension wires disposed between the optical fiber and the sheath according to the invention is configured of a tubular crimping ring, and a tubular crimping seat arranged inside the crimping ring, wherein the crimping seat has a protruding portion at outer circumferential portion thereof between a forward end face of the crimping seat and a forward end face of the sheath, from which expanding to outside to have a radius equal to or longer than a radius of outer circumference of the sheath or a radius of outer circumferential surface of the tension wires, and the sheath and/or the tension wires are interposed between the crimping ring and the crimping seat, and the optical fiber is inserted through the crimping seat from a rear side to a front side, and the crimping ring is crimped inward toward the crimping seat, so that the crimping seat is latched on and fixed to the crimping ring because a step corresponding to the crimping seat is formed on the crimping ring so that the crimping seat cannot be moved to the rear with respect to the crimping ring.

The tension wires interposed between the sheath and the optical fiber may be folded from the forward end face of the sheath to the rear near the protruding portion of the crimping seat, and the folded tension wires may be crimped by the crimping ring together with the sheath.

Moreover, concave grooves formed parallel to one another in a circumferential direction may be provided on an outer circumferential surface of the crimping seat, so that the sheath is crimped by the crimping ring with increased fixing force at the grooves. A concave groove formed in a spiral shape may be used. The concave groove is preferably made to have rounded corners, or to be in a smooth waveform in order to prevent formation of a sharp edge.

### Effect of the Invention

According to the fixing structure of the optical cable of the invention, the protruding portion provided on the crimping seat is fixed at its stepped portion to a front portion of the crimped crimping ring, so that the crimping seat cannot be moved to rear with respect to the crimping ring. Therefore, when the optical cable is drawn to the rear by external force in a connected optical connector or the like, the crimping seat and the crimping ring are drawn to the back side through the sheath of the crimped optical cable; however, since the crimping ring is contacted to an inner wall surface of a housing of the optical connector and the like so as to be prevented from moving to the back side, the crimping seat, whose protruding portion is latched on the crimping ring, is also prevented from moving to the back side. In this way, even if the optical cable is drawn to the rear, the cable is prevented from moving to the rear, and consequently the crimping seat is prevented from moving relative to the crimping ring and coming out from the ring. Accordingly, stable optical communication is achieved, leading to improvement in reliability.

Moreover, the tension wires (Kevlar fibers) are folded at the forward end face of the sheath and crimped, so that sufficient thickness is secured by the sheath and the tension wires interposed between the crimping ring and the crimping seat, and consequently even if there is change in thickness of the sheath, or unevenness in distribution or amount of the tension wires in the optical cable, the crimping by the crimping ring is performed securely and firmly.

Furthermore, by providing concave grooves on the outer circumferential surface of the crimping seat, the sheath crimped by the crimping ring digs into the grooves, thereby increasing fixing force.

### BRIEF DESCRIPTION OF DRAWINGS

FIG. 1 is a front view showing partially in section an optical connector having a fixing structure of an optical cable according to an embodiment of the invention;

FIG. 2 is a plan view showing the optical connector;

FIG. 3 is a side view showing the optical connector;

FIG. 4A is a side view showing partially in section the optical connector before fixing the optical cable by a crimping ring and a crimping seat;

FIG. 4B is a side view showing partially in section the optical connector after fixing the optical cable by the crimping ring and the crimping seat;

FIG. 5 is a plan view showing a structure of the optical cable;

FIG. 6A is a plan view showing another embodiment of the crimping seat of the optical connector;

FIG. 6B is a plan view showing still another embodiment of the crimping seat of the optical connector;

FIG. 7A is a partial section view showing a modification of a protruding portion of the crimping seat;

FIG. 7B is a partial section view showing a still another modification of the protruding portion of the crimping seat;

FIG. 7C is a partial section view showing a still another modification of the protruding portion of the crimping seat;

FIG. 8 is a front view showing partially in section a conventional optical connector; and

FIG. 9 is a side view showing partially in section a fixing structure of the optical cable according to the conventional optical connector.

### BEST MODE FOR CARRYING OUT THE INVENTION

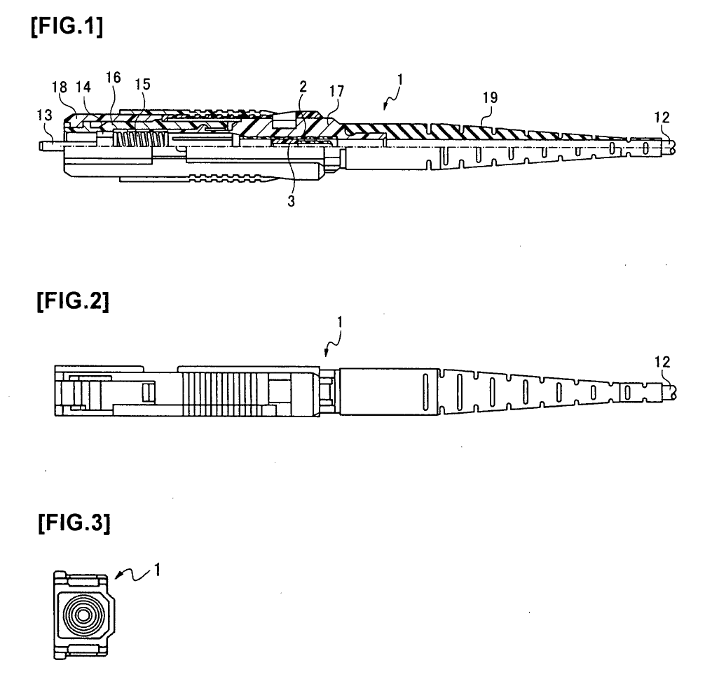

As shown in FIGS. 1 to 3, the fixing structure of an optical cable according to the invention is achieved in an optical connector 1. Portions corresponding to those in the conventional example are described with the same reference numbers as in the conventional example. In the optical connector 1, an optical cable 12 is inserted into a connector housing made of synthetic resin, which is formed by a plug frame 16, stop ring 17, and lug 18 and the like, along the axis of the housing, and fixed to the connector housing.

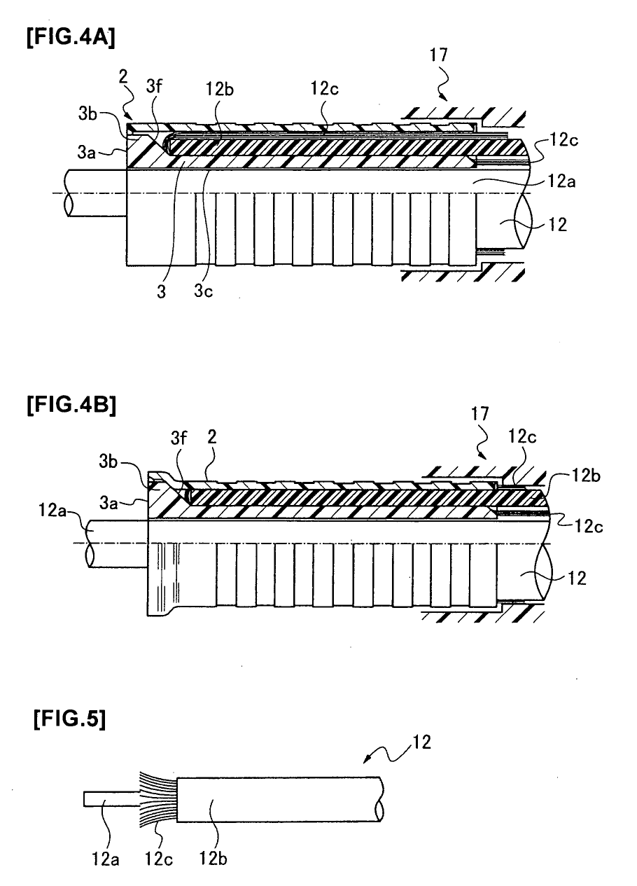

As shown in FIGS. 4A and 4B, a tubular crimping ring 2 made of metal, and a tubular crimping seat 3 made of metal situated inside the crimping ring 2 are arranged within the connector housing of the optical connector 1, a sheath 12b which is the shell of the optical cable 12, and tension wires (for example, Kevlar fibers) 12c, which are folded to cover the outer circumference of the sheath 12b, are interposed between the crimping ring 2 and the crimping seat 3.

A flange-like protruding portion 3b expanded to the outside is integrally formed on the outer circumference of the forward end portion of the crimping seat 3. The outer circumference diameter of the protruding portion 3b is made longer than the diameter of the sheath 12b so as to form a sufficient gap to interpose at least sheath 12b and the tension wires 12c which are folded over sheath 12b to cover the outer surface of sheath 12b, between the outer circumferential surface of the main body portion of the crimping seat 3 and the inner circumferential surface of the crimping ring 2.

The optical cable 12 includes an optical fiber 12a containing a core wire in the inside thereof, a sheath 12b which is the shell of the cable, and tension wires 12c for preventing the cable from being elongated, which are arranged between the optical fiber 12a and the sheath 12b uniformly along the circumference. While a case which the sheath 12b and the tension wires 12c are provided on the outer circumference of the optical fiber 12a is described in this example, the invention can be applied to an optical connector 1 for an optical cable 12 in which only the sheath 12b is provided on the outer circumference of the optical fiber 12a, or in which only the tension wires 12c are provided thereon.

When the optical cable 12 is fixed to the optical connector 1, first, as shown in FIG. 5, the sheath 12b is cut at a required position toward the forward end of the optical cable 12 so that the optical fiber 12a and the tension wires 12c are exposed. The tension wires 12c are cut to the same required length. Then, the crimping seat 3 is inserted from its rear end side into a through-hole 3c inside the sheath 12b and the tension wires 12c from its end toward the forward end of the optical fiber 12a (see FIG. 4A). At that time, the crimping seat 3 is inserted until the forward end of the sheath 12b reaches to a point close to the protruding portion 3b on the crimping seat 3. Thus, the tension wires 12c and the sheath 12b are separated along the outer circumferential surface of the crimping seat.

Next, the evenly cut tension wires 12c are folded to the rear so as to cover the outer circumference of the sheath 12b. This is performed in order to increase fixing force by crimping. At that time, the tension wires 12c are uniformly distributed without deviation along the outer circumference of the crimping seat 3, and the folded portion is uniformly distributed without deviation along the outer circumference of the sheath 12b. This is performed in order to prevent the fixing force from being non-uniform along the circumference. The crimping ring 2 is inserted from the forward end of the optical fiber 12a to cover the crimping seat 3, sheath 12b, and folded tension wires 12c (see FIG. 4A).

When the crimping ring 2 is inserted and then the condition as shown in FIG. 4A is achieved, the crimping ring 2 is crimped inward to the crimping seat 3 using a crimping tool, and thereby the optical cable 12 is fixed. Thus, as shown in FIG. 4B, the body portion of the crimping ring 2 is reduced in diameter, so that it presses the sheath 12b, tension wires 12c, and folded tension wires 12c in a radial direction to firmly hold them. By such crimping, the front portion of the crimping ring 2 contacting the protruding portion 3b is deformed so as to be larger in outside diameter than the main body of crimping ring 2 reduced in diameter, and consequently the front portion is latched on the protruding portion 3b (see FIG. 4B).

After that, the crimping ring 2, crimping seat 3, and optical cable 12 are returned to the inside of the connector housing of the optical connector 1, the forward end portion of the optical fiber 12a is bonded to the ferule 13 (see FIG. 1) and furthermore held by the holder 14, and the forward end faces of the ferule 13 and the optical fiber 12a are polished.

The optical connector 1 is configured in this way, and connected to another optical connector for use in optical communication. Even if the optical cable 12 is drawn to the rear opposite to the direction of connection, the crimping ring 2 abuts upon the inner wall surface of the stop ring 17, and in addition, the crimping seat 3 abuts upon the protruding portion 3b so as to be prevented from moving to the back side, as a result, neither the stop ring 2 nor the crimping seat 3 move to the back side, and one does not come out from the other. Accordingly, in optical communication using an optical cable, even if external force pulling upon the optical cable is exerted, communication continues and the cable can be used without interruption.

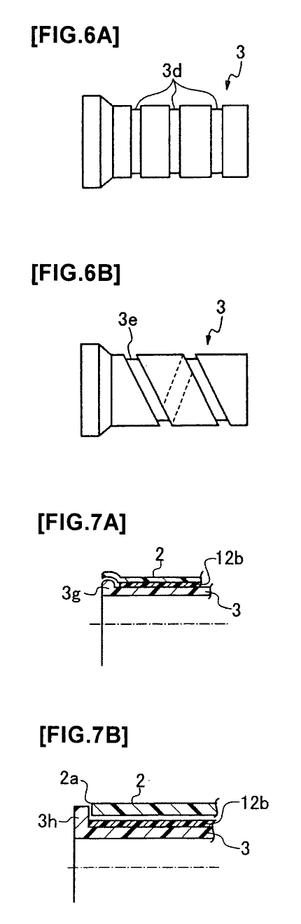

As shown in FIGS. 6A and 6B, the crimping seat 3 may have concave grooves 3d or a concave groove 3e on an outer circumferential surface. The concave grooves may be formed parallel to one another in a circumferential direction as shown in FIG. 6A. Alternatively, the concave groove may be formed spirally as shown in FIG. 6B. Thus, the crimped sheath 12b digs into the grooves 3d or groove 3e, leading to increase in fixing force. Since the groove is formed on the outer circumferential surface and not on the inner circumferential surface, less work is required.

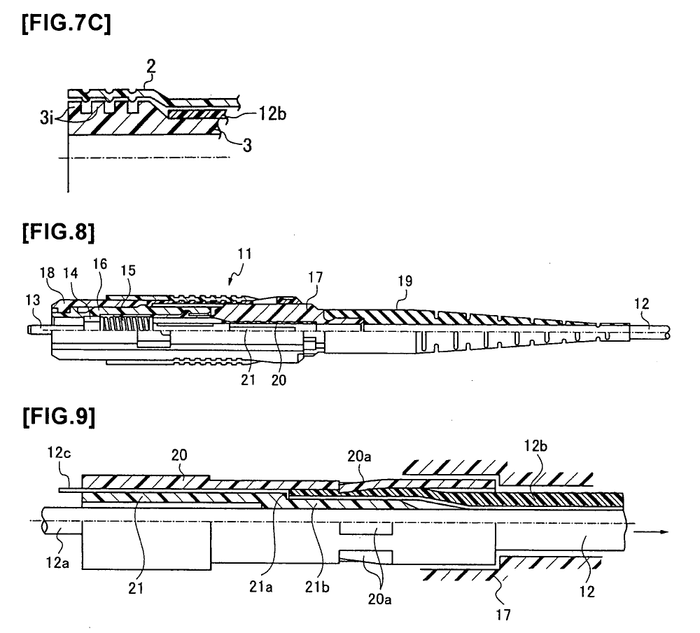

Furthermore, while the protruding portion 3b was expanded to the outside of the main body portion of the crimping seat 3 in the radial direction with a slope portion 3f between them reaching up to the outer circumference of the protruding portion 3b as shown in FIGS. 4A and 4B, the invention is not restricted to this. As a modification, for example, a protruding portion 3g formed in a semicircular shape may be used (FIG. 7A). Moreover, the protruding portion 3h may have a rectangular cross section, and the crimping ring 2 may have the same length as the length of the sheath 12b up to the forward end face (FIG. 7B). In this way, the protruding portion 3h is securely contacted to the forward end face 2a of the crimping ring 2. Furthermore, as shown in FIG. 7C, protruding portion 3i having a plurality of projecting steps may be used. In this case, a firmer latching state between the crimping ring and the crimping seat is achieved.

### INDUSTRIAL APPLICABILITY

In the fixing structure of the optical cable according to the invention, the crimping ring for fixing the optical cable and the crimping seat are firmly crimped together so as to prevent one from coming out of the other, and even if pulling force is applied to the optical cable, strong fixing force is exhibited so that there is no interruption of optical communication, and therefore the structure is useful as a fixing structure of an optical cable in an optical connector and the like.

1. A fixing structure of an optical cable composed of a optical fiber, a sheath and tension wires disposed between the optical fiber and the sheath, comprising a tubular crimping ring, and a tubular crimping seat arranged inside the crimping ring, wherein
the crimping seat has a protruding portion at outer circumferential portion thereof between a forward end face of the crimping seat and a forward end face of the sheath, from which expanding to outside to have a radius equal to or longer than a radius of outer circumference of the sheath or a radius of outer circumferential surface of the tension wires, and
the sheath and/or the tension wires are interposed between the crimping ring and the crimping seat, and the optical fiber is inserted through the crimping seat from a rear side to a front side, and the crimping ring is crimped inward toward the crimping seat, so that the crimping seat is latched on and fixed to the crimping ring because a step corresponding to the crimping seat is formed on the crimping ring so that the crimping seat cannot be moved to the rear with respect to the crimping ring.

2. The fixing structure of an optical cable according to claim 1, wherein the tension wires interposed between the sheath and the optical fiber are folded from the forward end face of the sheath near the protruding portion of the crimping seat to the rear, and the folded tension wires are crimped by the crimping ring together with the sheath.

3. The fixing structure of an optical cable according to claim 1, wherein concave grooves made parallel to one another in a circumferential direction are provided on the outer circumferential surface of the crimping seat, so that the sheath crimped by the crimping ring digs in the grooves to increase fixing force.

4. The fixing structure of an optical cable according to claim 1, wherein a concave groove made in a spiral form is provided on the outer circumferential surface of the crimping seat, so that the sheath crimped by the crimping ring digs in the groove to increase fixing force.

5. The fixing structure of an optical cable according to claim 2, wherein concave grooves made parallel to one another in a circumferential direction are provided on the outer circumferential surface of the crimping seat, so that the sheath crimped by the crimping ring digs in the grooves to increase fixing force.

6. The fixing structure of an optical cable according to claim 2, wherein a concave groove made in a spiral form is provided on the outer circumferential surface of the crimping seat, so that the sheath crimped by the crimping ring digs in the groove to increase fixing force.
